(19) United States
(12) Patent Application Publication
(10) Pub. No.: US 2011/0243532 A1
(43) Pub. Date: Oct. 6, 2011

(54) SYSTEM AND METHOD OF VIDEO STABILIZATION DURING MOVEMENT

(75) Inventors: Joseph W. Bostaph, Chandler, AZ (US); Manuel Oliver, Scottsdale, AZ (US); Daniel J. Sadler, Gilbert, AZ (US)

(73) Assignee: MOTOROLA, INC., Schaumburg, IL (US)

(21) Appl. No.: 12/751,417

(22) Filed: Mar. 31, 2010

(51) Int. Cl. H04N 5/93; G11B 27/00

(52) U.S. Cl. 386/278

(57) ABSTRACT

Methods for video stabilization during movement include capturing a video stream by an imaging system of a video stabilization system. The video stream includes a plurality of image frames. As the video stream is captured, a motion sensor of the video stabilization system detects a pattern of recurring motion. Motion sensor data is generated for the sequence of image frames that characterizes the pattern of recurring motion. At least one image frame of the sequence of image frames is edited based on a comparison of the motion sensor data for the sequence of image frames to motion sensor data for a region of interest for the imaging system.

### TECHNICAL FIELD

The present disclosure relates generally to video systems and in particular to a system and method of video stabilization during movement.

### BACKGROUND

With ever increasing technological advances in camera and video technology, cameras and video recorders as incorporated within an array of portable electronic devices are becoming a ubiquitous aspect for enhancing our everyday lives. In one illustration, personal video recorders are integrated within remote speaker microphones as used by law enforcement officers and first responders in an effort to ensure their individual well-being, act as a deterrent so as to improve overall public safety, and enhance the quality and process of collecting legal evidence. In other cases, personal video recorders are implemented as stand-alone devices.

Ideally, a captured video stream would also simplify the process of indisputably establishing the facts in a particular incident and would provide other valuable legal evidence while law enforcement officials or other first responders are engaged in that particular incident. Optionally, a wearable video recorder provides real-time awareness to remote viewers to enhance responsiveness to a dynamically changing situation.

In practice, a wearable video recorder is worn by a user at any of a variety of locations, such as their shoulder, chest, waist, head or elsewhere. As the video recorder moves in tandem with the wearer during activity such as standing/sitting, walking, running or other movements, the resulting captured video stream often features image frames that vary suddenly and widely such that it is difficult to view a desired reference area. Currently, an electronic image stabilization (EIS) system technology is used to remove jitter or other small, irregular movements. However, an EIS system cannot correct for the larger movements encountered during increased or non-stable activity as referenced above.

Accordingly, there is a need for a system and method of video stabilization during movement.

### BRIEF DESCRIPTION OF THE FIGURES

The accompanying figures, where like reference numerals refer to identical or functionally similar elements throughout the separate views, together with the detailed description below, are incorporated in and form part of the specification and serve to further illustrate various embodiments of concepts that include the claimed invention, and to explain various principles and advantages of those embodiments.

FIG. 1 illustrates a method of video stabilization in accordance with illustrative embodiments of the present disclosure.

FIG. 2 illustrates a video stabilization system in accordance with some embodiments.

FIG. 3 illustrates a method of video stabilization for an imaging system undergoing a pattern of recurring motion in accordance with at least one embodiment.

FIG. 4 illustrates a sequence of image frames for an imaging system undergoing a pattern of recurring motion in accordance with some embodiments.

FIG. 5 illustrates motion of a field of view in accordance with at least one embodiment.

FIG. 6 illustrates a system and method of editing a video stream in accordance with some embodiments.

FIG. 7 illustrates a system and method of editing a video stream in accordance with other embodiments.

FIG. 8 is a logical flowchart showing an illustrative method for editing a video stream in accordance with some embodiments.

FIG. 9 is a logical flowchart showing an illustrative method for editing a video stream in accordance with other embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, the present disclosure provides a system and method of video stabilization during movement, such as a video stabilization system featuring an imaging system and a motion sensor. The imaging system moves in tandem with a wearer during activity while the motion sensor detects motion of the imaging system. Specifically, illustrative embodiments of the present disclosure are described below with reference to wearable video recorders. However, at least some of the illustrative embodiments and their associated advantages can be implemented and appreciated in a variety of other video systems capable of supporting the systems and methods as described herein. Further, embodiments of the present disclosure are described herein with reference to applications in law enforcement as well as associated with other first responders. However, at least some of the illustrative embodiments as described below can be implemented in a variety of other applications and settings including business, security or other commercial use, as well as personal and recreational use.

As described herein, methods for video stabilization during movement include a method for editing a video stream by a video stabilization system that features an imaging system and a motion sensor. The video stream includes a sequence of image frames captured by the imaging system. As the video stream is captured, the motion sensor from the video stabilization system detects a pattern of recurring motion. The video stabilization system generates motion sensor data for the sequence of image frames that characterizes, corresponds to, and represents the pattern of recurring motion. In some embodiments, at least one image frame of the sequence of image frames is edited based on a comparison of the motion sensor data for the sequence of image frames to motion sensor data for a region of interest for the imaging system.

Optionally, the video stream and the motion sensor data are synchronized, for example, by a time stamp in order to facilitate the editing of the at least one image frame. In some embodiments, the unedited video stream is recovered from the edited video stream. It may be desirable, for example, to view the original, unedited video stream, or to select a different region of interest or reference frame, as discussed below, for editing of the video stream.

A video stabilization system includes a processor. Methods for stabilizing a video stream by the video stabilization system include receiving a video stream from an imaging system. The video stream includes a plurality of image frames. The processor receives motion sensor data for a set of image frames of the plurality of image frames. The motion sensor data characterizes a pattern of recurring motion for the imaging system. The video stabilization system determines an image orientation. Based on a comparison of the motion sensor data to the image orientation, at least one image frame from the set of image frames is edited at the processor.

A system for video stabilization as disclosed herein includes an imaging system, a motion sensor coupled to the imaging system, and a processor coupled to the motion sensor. The imaging system captures a video stream including a plurality of image frames. The motion sensor detects a pattern of recurring motion of the imaging system and generates corresponding motion sensor data. The processor edits at least one of the plurality of image frames based on the motion sensor data corresponding to the pattern of recurring motion of the imaging system.

The embodiments as disclosed herein can generally be applied to any mobile imaging system experiencing a pattern of recurring motion. Further, the benefits and advantages as described herein are also applicable to systems employing electronic image stabilization (EIS) technology as well as other hardware and software devices that are capable of supporting the embodiments disclosed below. Those skilled in the art will realize that the above recognized advantages and other advantages described herein are merely illustrative and are not meant to be a complete rendering of all of the advantages of the various embodiments.

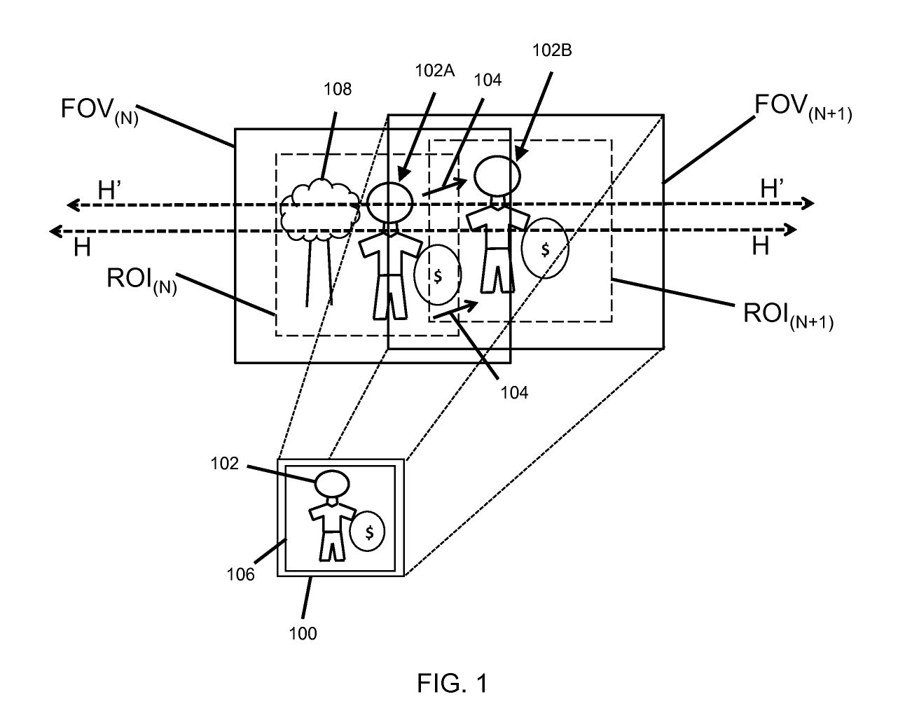

Referring now to the figures, FIG. 1 shows a method of video stabilization during recurring movement of an imaging system in accordance with illustrative embodiments of the present disclosure. In addition, FIG. 1 illustrates various methods for selecting a region of interest of the imaging system in accordance with various embodiments. As used herein, the term “region of interest” (ROI) is used to define a region that includes a desired image orientation, a desired reference object or other desired area/object of interest. Also, as used herein, the term “field of view” (FOV) is used to define a total observable region for a given imaging system.

Consequently, in various embodiments, the FOV is directly dependent on a lens or set of optics that is used in the imaging system. In some embodiments, the ROI includes the entire FOV. Alternatively, the ROI includes a subset of the entire FOV. In some instances, the ROI is completely outside the FOV.

FIG. 1 shows one illustrative depiction of, among others, a law enforcement officer pursuing a suspect 102 and where various aspects of the present disclosure are implemented. The officer utilizes a video stabilization system 100, that includes an imaging system and a motion sensor, to capture a video stream of the suspect 102 as the suspect moves from a position 102A to a position 102B, as indicated by arrows 104. The video stabilization system includes a wearable video recorder that is coupled to the officer at any of a variety of locations, such as at the shoulder, chest, waist, head or elsewhere. As the video recorder moves in tandem with the officer while in vigorous pursuit of the suspect 102, the resulting captured video stream features a sequence of image frames that vary suddenly and widely such that it is difficult to view the desired region of interest, ROI. For example, a FOV of the imaging system moves from a FOV(N) to a FOV(N+1) as the suspect moves from the position 102A to the position 102B and the pursuing officer responsively redirects efforts in pursuit of the suspect. As shown, a single region of interest ROI(N) is defined for the FOV(N) and the FOV(N+1). Thus, as the imaging system moves from the FOV(N) to the FOV(N+1), only a portion of the ROI(N) is viewable to the FOV(N+1). Alternatively, a different region of interest ROI(N+1) is defined for the FOV(N+1). Generally, each of the ROI(N) and the ROI(N+1) are determined or defined according to one or more of a plurality of methods.

Illustratively, in some embodiments, a region of interest, ROI, is determined according to a desired image orientation, where the motion sensor determines an orientation of the imaging system by measuring a direction of acceleration due to gravity. For example, an orientation of the imaging system, and thus the region of interest, is determined such that the selected region of interest aligns with forward motion of the officer while in pursuit of the suspect 102. Alternatively, the region of interest is determined by selecting a fixed reference object within the field of view of the imaging system, such as a tree 108. In other embodiments, the region of interest is automatically determined, for example, by using motion sensor data for the sequence of image frames and/or by detection of a horizon, as indicated by a dashed line H corresponding to FOV(N) and a dashed line H′ corresponding to FOV(N+1). Optionally, the region of interest is configured using external input such as by being selected manually by a user based on a specific situation or other preference.

In some embodiments, as the video recorder moves in tandem with the officer while in pursuit of the suspect 102, the motion sensor detects a pattern of recurring motion. Illustratively, the video stabilization system 100 edits the video stream by selecting, removing, rotating, shifting or otherwise editing a set or subset of image frames of the video stream. The edited image frames are either partially or completely outside of the desired region of interest, for example, as determined by the motion sensor. Alternatively, the edited image frames are shifted and/or rotated and are still completely within the region of interest. As used herein, an unedited video stream is equivalently referred to as a “raw video stream”. Likewise, as used herein, an edited video stream is equivalently referred to as a “corrected video stream”, a “smoothed video stream” or a “stabilized video stream”.

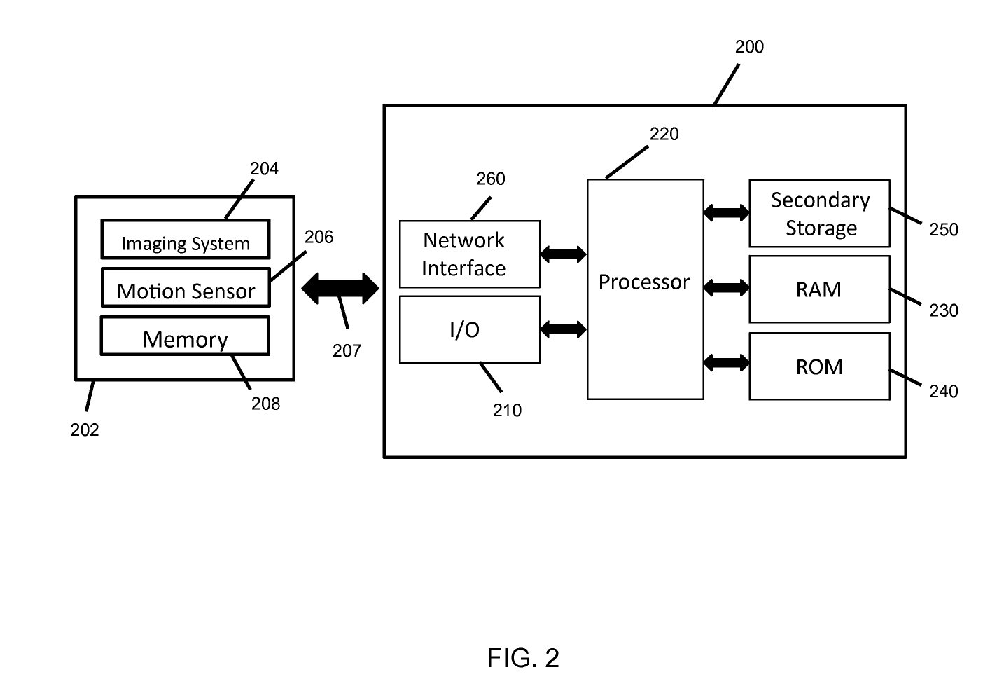

In some embodiments, the raw video stream is edited either locally or remotely in real-time or during video stream capture, wherein real-time means with negligible time delay. The resulting corrected video stream of the suspect's 102 pursuit is monitored remotely, for example, by transmitting the video stream to a command center, individual supervising personnel, other officers in the field searching for the suspect 102, or other support personnel. Thus, as the officer pursues the suspect 102, the command center or other support personnel are able to enhance their responsiveness to a dynamically changing situation and readily deduce critical information, for example, what additional support is needed, a location of the incident in progress, and an identification of the suspect 102, among others. In addition, in some embodiments, the video stabilization system 100 includes a display 106 for local viewing of the video stream as captured by the imaging system. Various embodiments of the present disclosure for acquiring and editing a video stream based on motion sensor data are discussed in further detail below with reference to FIGS. 2-9.

FIG. 2 illustrates a video stabilization system 202 in accordance with various embodiments. The video stabilization system 202 includes an imaging system 204 for capturing a video stream. The imaging system 204 includes a video recorder having an image sensor such as, for example, a charge-coupled device (CCD) image sensor, a complementary metal-oxide-semiconductor (CMOS) image sensor or other image sensor. The video stabilization system 202 further includes a motion sensor 206 for detecting patterns of recurring motion, for determining an orientation of the imaging system 204, and for generating motion sensor data that characterizes the recurring motion and/or the orientation of the imaging system 204. In various embodiments, the motion sensor 206 includes one or more of the following: an accelerometer; a gyroscope; a magnetometer; an optical motion sensor; a piezoelectric sensor; or a microelectromechanical system (MEMS)-based sensor. In some embodiments, the video stabilization system further includes a memory 208 for local storage of motion sensor data and/or video stream data.

As indicated by an arrow 207, the video stabilization system 202 is coupled to a general-purpose computer system 200 by way of, for example, any well-known combination of a wired and/or wireless network connection. The computer system 200 is suitable for implementing one or more embodiments as herein described, including editing of a captured video stream based on motion sensor data. Further, the computer system 200 includes a local or remote computer system optimally configured for real-time and/or post-processing of the video stream, wherein post-processing means at the termination or end of or after the video stream capture. In particular, the computer system 200 comprises a processor 220, which is often referred to as a central processor unit or CPU, that is in communication with various memory devices including a secondary storage 250, a read only memory (ROM) 240, a random access memory (RAM) 230, a plurality of input/output (I/O) devices 210, and a plurality of network connectivity devices 260. Furthermore, the processor 220 can send and/or receive data from the memory 208 of the video stabilization system 202 by way of the network connection as indicated by the arrow 207. The processor can be implemented as one or more CPU chips.

The secondary storage 250 comprises one or more disk drives or tape drives. The secondary storage 250 is used for non-volatile storage of data and as an overflow data storage device if the RAM 230 is not large enough to hold all working data. The secondary storage 250 can be used to store programs that are loaded into the RAM 230 when selected for execution. The ROM 240 is used to store instructions and perhaps data, which are read during program execution. The ROM 240 is a non-volatile memory device that often has a small memory capacity relative to the larger memory capacity of secondary storage. The RAM 230 is used to store volatile data and optionally to store instructions. Access to both the ROM 240 and the RAM 230 is often faster than accessing the secondary storage 250.

Illustratively, the plurality of I/O devices 210 include printers, video monitors, liquid crystal displays (LCDs), touch screen displays, keyboards, keypads, switches, dials, mice, track balls, voice recognizers, card readers, paper tape readers, or other well-known input devices. The plurality of network connectivity devices 260 can comprise, among others, modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices.

These plurality of network connectivity devices 260, for instance, enable the processor 220 to communicate with a global information system or one or more intranets. With such a network connection, the processor 220 receives information from a connected network or outputs information to the network in the course of implementing one or more of the embodiments as described herein. The information is received by the processor 220 and provided to the network in a variety of formats such as, among others, a computer data baseband signal and a signal embodied in a carrier wave. In one illustrative embodiment, the information comprises data and instructions for execution by the processor 220.

In one illustrative implementation, the baseband signal or signal embodied in the carrier wave generated by the plurality of network connectivity 260 devices propagates in or on the surface of electrical conductors, in coaxial cables, in waveguides, in optical media such as optical fiber, or in the air or free space. In another illustrative implementation, the information contained in the baseband signal or signal embedded in the carrier wave is arranged in accordance with different sequences that are desired for processing, generating the information, transmitting, and receiving the information. The baseband signal or signal embedded in the carrier wave, or other types of signals currently used or hereafter developed, referred to herein as the transmission medium, are readily generated according to several methods well-known to one skilled in the art. The processor 220 executes instructions, codes, computer programs, scripts which it accesses from the ROM 240, the RAM 230, the plurality of network connectivity devices 260 or from a hard disk, a floppy disk, and/or an optical disk, where various disk-based systems are considered as the secondary storage 250.

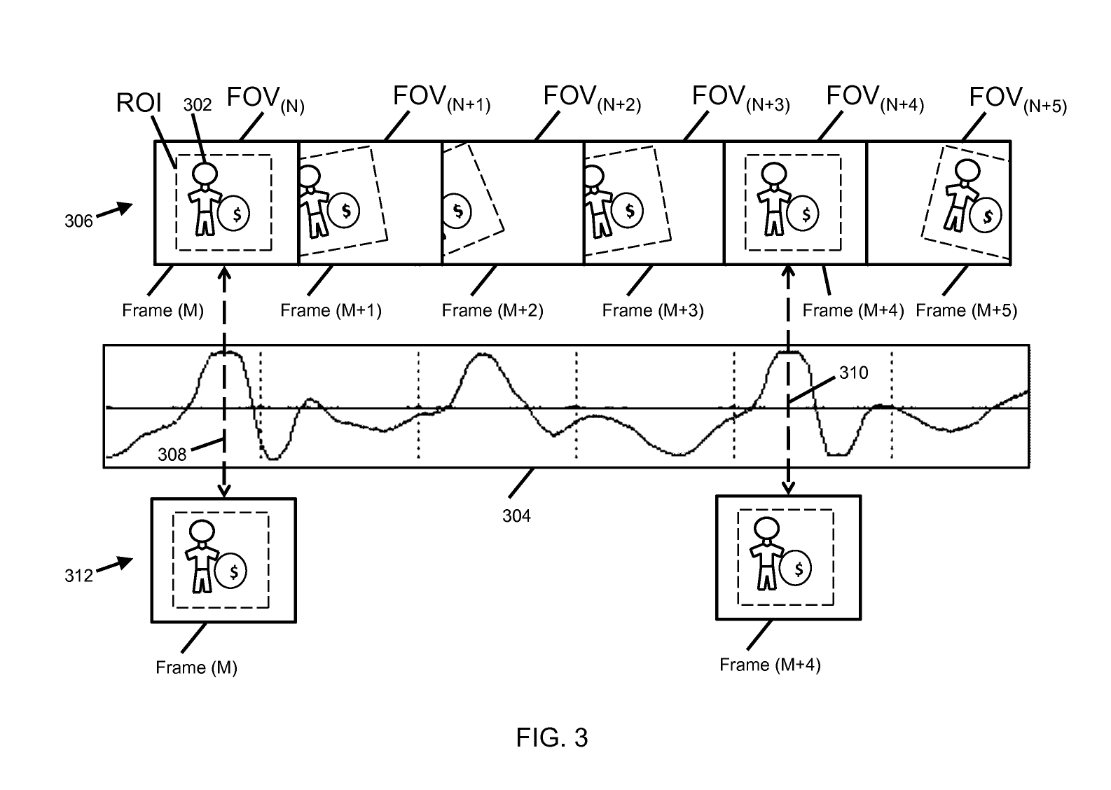

Referring now to FIG. 3, a method of video stabilization for an imaging system undergoing a pattern of recurring motion in accordance with at least one embodiment is illustrated. In particular, FIG. 3 includes an extension of the example discussed with reference to FIG. 1, where a law enforcement officer is pursuing a suspect 302. The officer, equipped with a video stabilization system having an imaging system and a motion sensor, records an unedited video stream or “raw video stream” 306 while pursuing the suspect 302. The imaging system and motion sensor move in tandem with the officer as the officer runs in vigorous pursuit of the suspect 302. The resulting captured video stream 306 features a sequence of image frames M, M+1, M+2, M+3, M+4, and M+5 corresponding to a plurality of positions N, N+1, N+2, N+3, N+4, N+5 of a FOV for the imaging system. The image frames vary in a recurring manner in accordance with the orientation of the imaging system such that it is difficult to view the desired region of interest (ROI) as defined for the FOV(N). In addition, the motion sensor detects the pattern of recurring motion due to the running motion of the officer and generates motion sensor data 304 that characterizes the pattern of recurring motion for the imaging system.

As used herein, a “pattern of recurring motion” includes a computer-recognizable pattern or trend in the motion sensor data. In some embodiments, the pattern of recurring motion includes periodic motion. However, embodiments of the present disclosure are not meant to be limited to periodic motion, but instead are meant to include any computer-recognizable pattern of recurring motion. Thus, the various embodiments as disclosed herein take into account variations introduced by differences in individual gait, body height and weight, differences in walking and running speeds, and variations occurring when alternating between running and walking motions, among others. For instance, in one illustrative implementation, the pattern of recurring motion is detecting by comparing the motion sensor data for the image frames to stored threshold motion sensor data or stored patterns or using any suitable pattern recognition algorithm.

Still referring to FIG. 3, the pattern of recurring motion of the imaging system includes movement of the FOV through the plurality of positions N, N+1, N+2, N+3, N+4, N+5. Varying portions of the ROI are visible in each image frame of the sequence of image frames as the FOV of the imaging system experiences the pattern of recurring motion. In some cases, the movement of the imaging system is large enough that the ROI is completely outside of the FOV.

The motion sensor data 304 comprises a computer-recognizable pattern that corresponds to the movement of the FOV of the imaging system through the sequence of positions N, N+1, N+2, N+3, N+4, N+5, as shown. In particular, the motion sensor data 304 varies in accordance with the orientation of the FOV. Thus, the pattern present in the motion sensor data 304 is representative of the orientation of the FOV of the imaging system, where similar patterns in the motion sensor data 304 correspond to similar orientations of the FOV. For example, the similar patterns in the motion sensor data 304 at positions as indicated by an arrow 308 and an arrow 310 correspond to similar orientations of the FOV(N) and the FOV(N+4), as represented by the image frames M and M+4.

Accordingly, in some embodiments, it is desirable to edit the raw video stream 306 such that an edited video stream comprises only those image frames having a desired image orientation as determined by the motion sensor data 304. In this example, it is desirable to construct an edited video stream that comprises only those image frames where the FOV includes the entire ROI such as, for example, the image frames M and M+4. Thus, an edited video stream 312, comprising the image frames M and M+4, is constructed from the raw video stream 306 by comparison of the motion sensor data 304 for the sequence of image frames to motion sensor data for the ROI as defined for the imaging system, for example corresponding to the FOV(N). As shown, the raw video stream 306 has a greater frame rate than the edited video stream 312. However, in some embodiments as discussed below, the raw video stream 306 and the edited video stream 312 have equal frame rates.

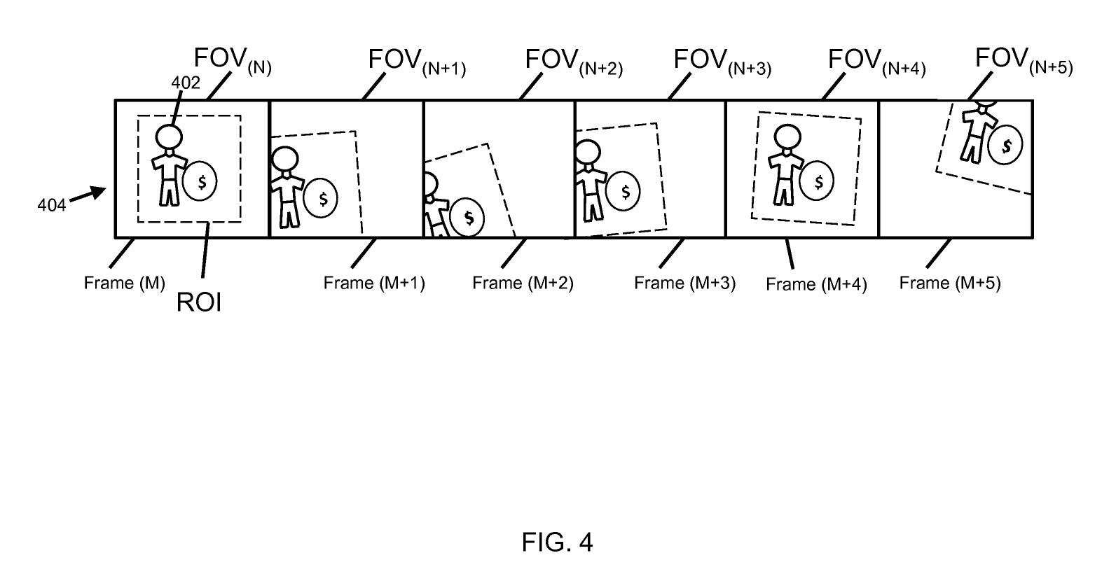

FIG. 4 illustrates a sequence of image frames for an imaging system undergoing a pattern of recurring motion in accordance with some embodiments. In particular, a video stream 404 features a sequence of image frames M, M+1, M+2, M+3, M+4, and M+5 that vary in a recurring manner in accordance with the orientation of the imaging system. A desired ROI is defined for a FOV(N) as shown. A FOV of the imaging system moves through a plurality of positions N, N+1, N+2, N+3, N+4, and N+5, where varying portions of the ROI as defined for the FOV(N) are visible in each image frame of the sequence of image frames of the video stream 404. In particular, the motion of the FOV shows vertical as well as horizontal displacement. Moreover, in some embodiments, an edited video stream may be constructed from, for example, the image frames M and M+4, where the FOV(N) and the FOV(N+4) have similar, but not exactly matching orientations. For example, although the orientation of the FOV(N) and the FOV(N+4) are not an exact match, a detectable pattern may still exist in the corresponding motion sensor data. Moreover, the image frames M and M=4 of the edited video stream may be further edited by rotating and/or shifting the FOV(N+4) or the image frame M+4 to exactly or nearly exactly match the FOV(N) of the image frame M.

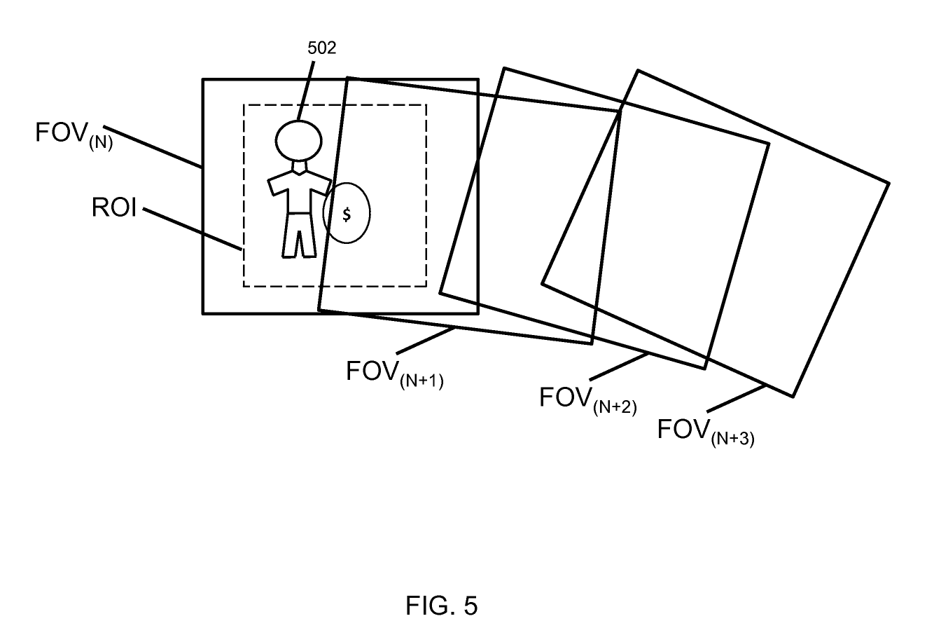

FIG. 5 illustrates a FOV of an imaging system undergoing movement, where the FOV comprises a ROI that includes a suspect 502. The FOV moves through a plurality of positions as indicated by FOV(N), FOV(N+1), FOV(N+2), and FOV(N+3). In this example, each of the positions as indicated by FOV(N), FOV(N+1), FOV(N+2), and FOV(N+3) are also meant to represent a single image frame of a video stream. As shown, the FOV(N) includes the entire ROI, while the FOV(N+1) is shifted and rotated with respect to the FOV(N) and includes only a portion of the ROI. Further, the FOV(N+2) is shifted and rotated with respect to the FOV(N+1) and does not include any of the ROI. Likewise, the FOV(N+3) is shifted and rotated with respect to the FOV(N+2) and does not include any of the ROI.

Illustratively, selection and editing of specific image frames, for example, that match motion sensor data corresponding to the ROI for correction of the captured video stream includes one or more of a plurality of editing processes such as, for instance: an image frame delete; an image frame crop; an image frame shift; or an image frame rotate. For example, as the FOV(N+1) is shifted and rotated with respect to the FOV(N) and includes a portion of the ROI, the image frame represented by the FOV(N+1) is corrected by shifting, rotating, and cropping the image frame. In like manner, as the FOV(N+2) and the FOV(N+3) do not include any of the ROI, the image frames represented by the FOV(N+2) and the FOV(N+3) are deleted or dropped. Thus, the unedited video stream has a greater frame rate than the corrected video stream. In other embodiments, the captured video stream is corrected without deletion of any of the original image frames. Thus, the unedited video stream and the corrected video stream have equal frame rates.

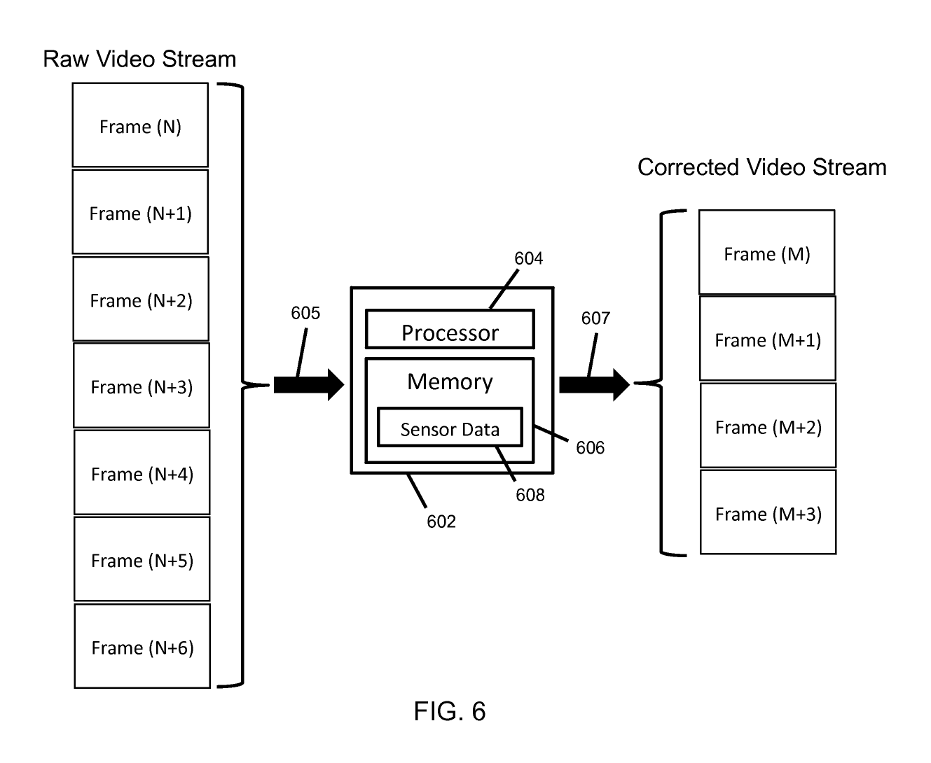

FIG. 6 illustrates a system and method of editing a video stream in accordance with some embodiments. As shown, an unedited video stream or “raw video stream” includes a plurality of image frames N, N+1, N+2, N+3, N+4, N+5, N+6. The raw video stream is transmitted to a computer system 602, as indicated by an arrow 605, where the computer system 602 includes a processor 604 and a memory 606 having motion sensor data 608 stored within the memory 606. The motion sensor data 608 characterizes a pattern of recurring motion for the sequence of image frames of the raw video stream.

On receipt of the motion sensor data 608 and the corresponding raw video stream, the processor 604 edits the raw video stream to generate a corrected video stream as indicated by an arrow 607. Accordingly, the raw video stream is edited based on a comparison of the motion sensor data for the sequence of image frames for the raw video stream to motion sensor data corresponding to a defined region of interest (ROI) for an imaging system of a video stabilization system.

As shown, the corrected video stream includes a plurality of image frames M, M+1, M+2, M+3. Thus, in the example of FIG. 6, the raw video stream has a greater frame rate than the corrected video stream. However, in some embodiments as discussed below, the raw video stream and the corrected video stream have equal frame rates.

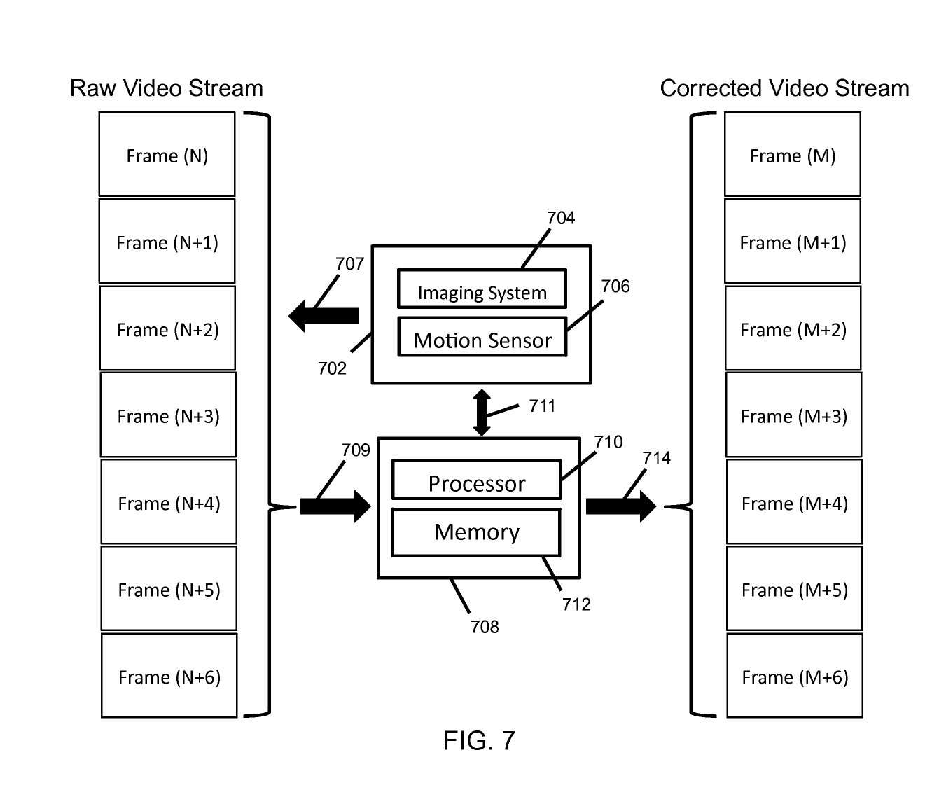

With further reference to FIG. 6, the notation of the raw and corrected video streams as either “N” or “M” image frames is meant to indicate that the editing of the raw “N” image frames includes one or more editing process such as cropping, shifting, or rotating, as opposed to only deleting individual “N” image frames. However, in other embodiments, the corrected video stream is constructed as a result of only deleting image frames of the raw video stream. Moreover, in contrast to the example discussed below with reference to FIG. 7, the example of FIG. 6 illustrates post-processing of the raw video stream, where the raw video stream is edited on completion of collection of the raw video stream and the motion sensor data 608.

FIG. 7 illustrates a system and method for real-time editing of a video stream in accordance with some embodiments. As shown, a video stabilization system 702 includes an imaging system 704 and a motion sensor 706. The imaging system 704 captures a raw video stream, as indicated by an arrow 707, where the raw video stream includes a plurality of image frames N, N+1, N+2, N+3, N+4, N+5, N+6. The motion sensor 706 detects a pattern of recurring motion of the imaging system 704 and generates motion sensor data that characterizes the pattern of recurring motion for the plurality of image frames of the raw video stream. The raw video stream and the motion sensor data are transmitted, for example, to a local or remote computer system 708 over a wired or wireless network connection while the raw video stream is being captured, as indicated by arrows 709 and 711. The computer system 708 includes a processor 710 and a memory 712 for storing the raw video stream and the motion sensor data as received from the video stabilization system 702.

On receipt of the motion sensor data and the corresponding raw video stream, the processor 710 edits, in real-time, the raw video stream to generate an edited or corrected video stream as indicated by an arrow 714, where the corrected video stream includes a plurality of image frames M, M+1, M+2, M+3, M+4, M+5, M+6. The editing of the raw video stream is based on a comparison of the motion sensor data for the sequence of image frames for the raw video stream to motion sensor data corresponding to a defined region of interest (ROI) for the imaging system 704 of the video stabilization system 702. As shown, the raw video stream and the corrected video stream have equal frame rates. However, in other embodiments of real-time processing, the raw video stream has a greater frame rate than the corrected video stream.

In some embodiments, such as in the example of a law enforcement officer pursuing a suspect as discussed above, the remote computer system 708 is located at a command center or at a location linked with other personnel remotely supporting the pursuit, where the corrected video stream is monitored in real-time. Thus, as the officer pursues the suspect, the command center or other support personnel are able to improve incident responsiveness by deducing, for example, whether additional support is needed, a general location of the suspect and of the incident in progress, and an identification of the suspect, among others. Optionally, the remote computer system 708 is located on the law enforcement officer, for example attached to the officer's uniform, where the captured video stream is corrected locally at the officer's location and the corrected video stream is transmitted to the command center, other support personnel, or other remote location.

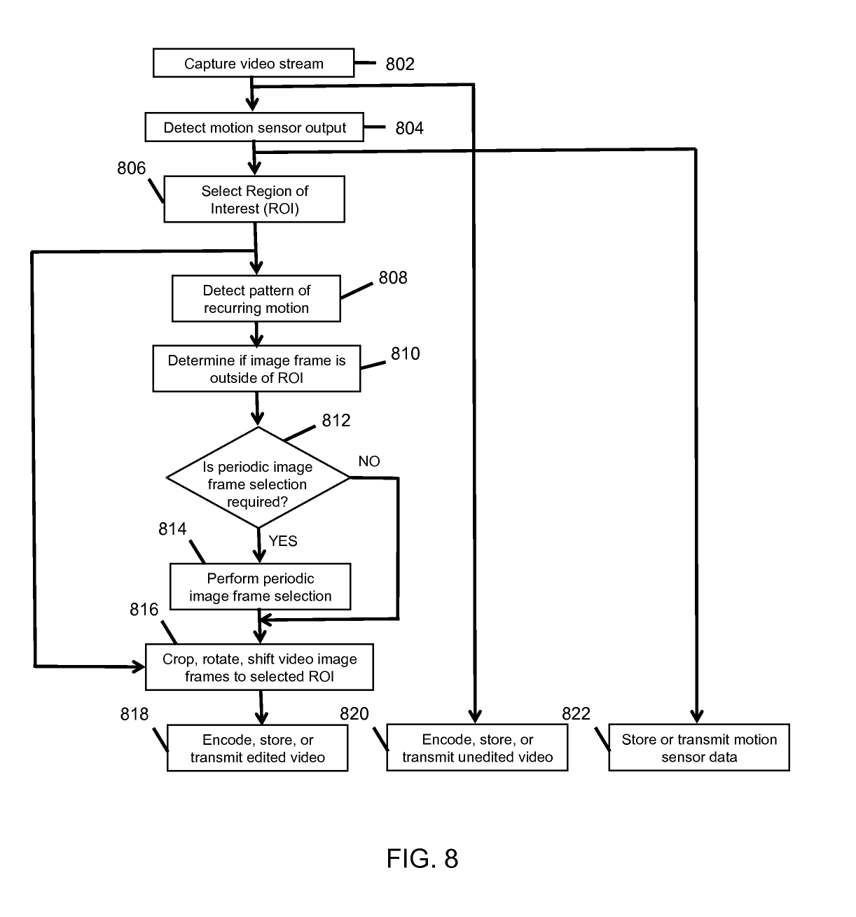

FIG. 8 shows a logical flowchart illustrating a method for editing a video stream in accordance with some embodiments. Accordingly, the method includes capturing a video stream (802). The video stream is captured by an imaging system of a video stabilization system. The video stream includes a plurality of image frames. The method detects motion sensor output (804), where the motion sensor output is used to determine an orientation of the imaging system and select a region of interest (806). In some embodiments, the region of interest is determined by selecting a fixed reference object within the field of view of the imaging system. In other embodiments, the region of interest is automatically determined by detection of a horizon. Alternatively, the region of interest is selected by a user-interface based on a specific situation, convenience or other preference.

In some embodiments, the motion sensor detects a pattern of recurring motion (808). If a pattern of recurring motion is detected at 808, the video stabilization system determines if image frames of the captured video stream are outside the region of interest (810). That is, the video stabilization system determines if the field of view, as represented by each of the image frames of the video stream, does not include any portion of the region of interest.

At 812, the video stabilization system determines if periodic frame selection is required. For example, if the video stabilization system determines that each of the image frames of the video stream include at least a portion of the region of interest, then periodic frame selection is not required. However, if the video stabilization system determines that one or more image frames of the captured video stream are outside the region of interest, then periodic frame selection is required, and the video stabilization system performs periodic image frame selection (814).

Still referring to FIG. 8, the image frames are cropped, rotated, and/or shifted to the selected region of interest (816), and a corrected video stream is generated. The corrected video stream is encoded, stored or transmitted (818). In some embodiments, on selection of the region of interest at 806, the video stream is directly cropped, rotated, and/or shifted to the selected region of interest at 816 and thus encoded, stored or transmitted at 818. Alternatively, the captured video stream is not edited. For example, after capturing the video stream (802) and motion sensor data (804), the unedited video is encoded, stored or transmitted (820), and the sensor data is encoded, stored, or transmitted (822) to enable a remote computer system to edit the raw video stream in accordance with the teachings herein. The unedited video and corresponding motion data can be sent as separate files (as illustrated) or combined into a single file, wherein, for instance, the motion data is stored as metadata in the unedited video file. Furthermore, in one illustrative implementation, the video stream and motion sensor data are synchronized, for example, by a time stamp in order to facilitate the editing of at least one image frame in the video stream.

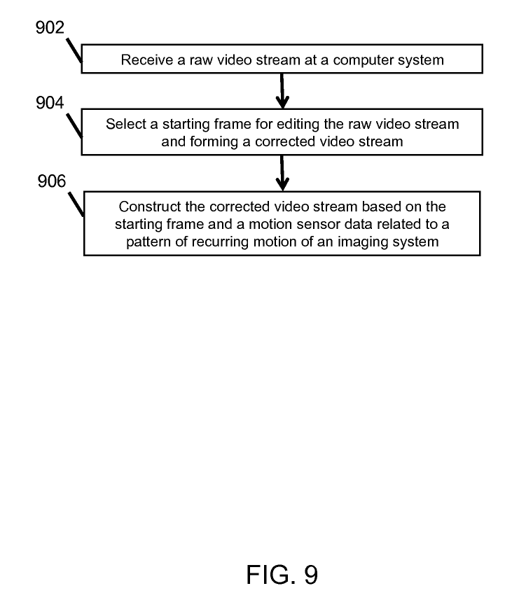

FIG. 9 shows a logical flowchart illustrating a method for editing a video stream in accordance with other embodiments. Accordingly, the method includes receiving a raw video stream at a computer system (902). The video stream is captured by an imaging system of a video stabilization system. The video stream includes a plurality of image frames. A starting or “reference” image frame for editing the raw video stream and forming a corrected video stream is selected (904). The reference frame is selected from the plurality of image frames of the video stream, where the reference frame includes corresponding motion sensor data that matches the motion sensor data for the region of interest. In some embodiments, the reference frame is arbitrarily selected according to convenience or other individual preference. A corrected video stream is constructed, at 906, based on the selected reference frame and the motion sensor data that characterizes a pattern of recurring motion for the sequence of image frames as captured by the imaging system of the video stabilization system. The method illustrated by reference to FIG. 9 can be performed in real-time or as a post-processing procedure. Moreover, the corrected video stream can be constructed using one or more of the editing techniques described by reference to FIGS. 1-8.

In the foregoing specification, specific embodiments have been described. However, one of ordinary skill in the art appreciates that various modifications and changes can be made without departing from the scope of the invention as set forth in the claims below. For example, in some embodiments, editing of the raw video stream is manually triggered. In other embodiments, editing of the raw video stream is automatically triggered based on detection of a pattern of recurring motion or based on detection of a threshold amount of movement as determined by a motion sensor. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. Also, the sequence of steps in a flow diagram or elements in the claims, even when preceded by a letter does not imply or require that sequence.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for editing a video stream, the method comprising:
a video stabilization system, comprising an imaging system and a motion sensor, performing:
capturing, from the imaging system, a video stream comprising a sequence of image frames;
detecting, at the motion sensor, a pattern of recurring motion of the imaging system; and
generating motion sensor data for the sequence of image frames characterizing the pattern of recurring motion;
wherein at least one image frame of the sequence of image frames is edited based on a comparison of the motion sensor data for the sequence of image frames to motion sensor data for a region of interest for the imaging system.

2. The method of claim 1, wherein editing the at least one image frame comprises:
during the video stream capture, selecting a set of image frames from the sequence of image frames, which have motion sensor data that matches the motion sensor data for the region of interest; and
constructing a corrected video stream using the selected set of image frames.

3. The method of claim 1, wherein editing the at least one image frame comprises:
during the video stream capture, selecting a reference image frame from the sequence of image frames, which has motion sensor data that matches the motion sensor data for the region of interest;
selecting a set of image frames subsequent to the reference image frame based on the motion sensor data for the sequence of image frames; and
constructing a corrected video stream using the selected reference image frame and the set of selected image frames.

4. The method of claim 1, wherein editing the at least one image frame comprises:
on termination of the video stream capture, selecting a set of image frames from the sequence of image frames, which have motion sensor data that matches the motion sensor data for the region of interest; and
constructing a corrected video stream using the selected set of image frames.

5. The method of claim 1, wherein editing the at least one image frame comprises:
on termination of the video stream capture, selecting a reference image frame from the sequence of image frames, which has motion sensor data that matches the motion sensor data for the region of interest;
selecting a set of image frames subsequent to the reference image frame based on the motion sensor data for the sequence of image frames; and
constructing a corrected video stream using the selected reference image frame and the set of selected image frames.

6. The method of claim 1 further comprising defining the region of interest for the imaging system, wherein editing the at least one image frame comprises selecting at least one image frame from the sequence of image frames that includes the region of interest to include in a corrected video stream.

7. The method of claim 1 further comprising defining the region of interest for the imaging system, wherein editing the at least one image frame comprises selecting at least one image frame from the sequence of image frames that is outside of the region of interest to exclude from a corrected video stream.

8. The method of claim 1, wherein the region of interest is configured using external input.

9. The method of claim 1, wherein the region of interest is automatically determined using the motion sensor data for the sequence of image frames.

10. A method for stabilizing a video stream, the method comprising:
a video stabilization system, including a processor, performing:
receiving, from an imaging system, a video stream comprising a plurality of image frames;
receiving, for a set of image frames of the plurality of image frames, motion sensor data characterizing a pattern of recurring motion for the imaging system;
determining an image orientation; and
editing, at the processor, at least one image frame from the set of image frames based on a comparison of the motion sensor data to the image orientation.

11. The method of claim 10, wherein the editing comprises:
selecting image frames from the set having motion sensor data that matches the image orientation; and
generating a stabilized video stream using the selected image frames.

12. The method of claim 11, wherein the video stream includes a first frame rate, and the stabilized video stream includes a second frame rate that is less than the first frame rate.

13. The method of claim 11, wherein the video stream includes a first frame rate, and the stabilized video stream includes a second frame rate that is equal to the first frame rate.

14. The method of claim 10, wherein the editing comprises:
selecting a reference image frame from the set having motion sensor data that matches the image orientation;
selecting, from the set and based on the motion sensor data characterizing the pattern of recurring motion for the imaging system, a subset of image frames subsequent to the reference image frame; and
generating a stabilized video stream using the selected reference image frame and the selected subset of image frames.

15. The method of claim 14, wherein the video stream includes a first frame rate, and the stabilized video stream includes a second frame rate that is less than the first frame rate.

16. The method of claim 14, wherein the video stream includes a first frame rate, and the stabilized video stream includes a second frame rate that is equal to the first frame rate.

17. A system for video stabilization comprising:
an imaging system that captures a video stream comprising a plurality of image frames;
a motion sensor, coupled to the imaging system, which detects a pattern of recurring motion of the imaging system and generates corresponding motion sensor data; and
a processor, coupled to the motion sensor, which edits at least one of the plurality of image frames based on the motion sensor data.

18. The system of claim 17, wherein the processor selects a set of image frames from the plurality of image frames based on the motion sensor data that matches a defined region of interest, and wherein the processor generates a corrected video stream using the selected set of image frames.

19. The system of claim 17, wherein the processor selects a reference image frame from the plurality of image frames based on the motion sensor data that matches a defined region of interest, wherein the processor selects a set of image frames from the plurality of image frames subsequent to the reference image frame based on the motion sensor data corresponding to the pattern of recurring motion of the imaging system, and wherein the processor generates a corrected video stream using the selected reference image frame and the set of selected image frames from the plurality of image frames.

20. The system of claim 17, wherein the motion sensor comprises at least one of: an accelerometer; a gyroscope; a magnetometer; an optical motion sensor; a piezoelectric sensor; or a microelectromechanical system (MEMS)-based sensor.
